(19) United States
(12) Patent Application Publication
(10) Pub. No.: US 2014/0102639 A1
(43) Pub. Date: Apr. 17, 2014

(54) PLASMA TREATMENT OF HOLLOW BODIES

(71) Applicant: Reinhausen Plasma GmbH, Regensburg (DE)

(72) Inventors: Stefan Nettesheim, Berlin (DE); Dariusz Korzec, Wenzenbach (DE)

(73) Assignee: Reinhausen Plasma GmbH, Regensburg (DE)

(21) Appl. No.: 14/138,304

(22) Filed: Dec. 23, 2013

Related U.S. Application Data
(63) Continuation of application No. PCT/EP2012/060497, filed on Jun. 4, 2012.

(30) Foreign Application Priority Data
Jul. 1, 2011 (DE) 102011107836.7

(51) Int. Cl. H05H 1/48

(52) U.S. Cl. CPC H05H 1/48
USPC 156/345.28; 134/1.1; 204/164; 118/723 R; 427/569; 422/186.05

(57) ABSTRACT

The invention relates to a device and a method for plasma treatment of hollow bodies. The invention is in particular suited for the protective plasma treatment of the inner surface of thermally sensitive hollow bodies such as plastic bottles. The plasma treatment according to the invention can, for example, consist of chemical activation, sterilization, cleaning or coating. One or more hollow bodies are put into a processing chamber for treatment. The processing chamber is in fluid connection with at least one plasma source. An exhaust device on the processing chamber generates a negative pressure in the processing chamber relative to the plasma source so that plasma can expand out of the plasma source into the processing chamber and hollow body.

### CROSS REFERENCE TO RELATED APPLICATIONS

This application is filed under 35 U.S.C. §120 and §365(c) as a continuation of International Patent Application PCT/EP2012/060497, filed Jun. 4, 2012, which application claims priority from German Patent Application No. 10 2011 107 836.7, filed Jul. 1, 2011, which applications are incorporated herein by reference in their entireties.

### FIELD OF THE INVENTION

The present invention relates to an apparatus and a method for the plasma treatment of hollow bodies.

Additionally the invention relates to a method for the plasma treatment of hollow bodies.

### BACKGROUND OF THE INVENTION

The invention is particularly suitable for the cleaning and further processing of bottles. If the bottles are intended to contain medication or beverages for consumption, the cleaning before filling has to meet strict hygiene criteria. Bottles made of plastics such as PET have the advantage of being, among other things, light and shatter-proof. Glasses, like silicon dioxide, however, have the advantage, among others, to form an inert and dense surface. With multi-layer systems the advantages of different materials may be combined. This requires a good adhesion between the layers even under thermal, mechanical or chemical strain, as occurs with repeated cleaning cycles of returnable bottles. For example, a PET bottle can be provided from the inside with a layer of glass and/or with a UH-absorbing layer. Another example is the selective alteration of the polymer structure on the inner surface of a plastic bottle. The German patent application DE 10 2008 037 159 A1 describes a device for the treatment of hollow bodies comprising a low pressure treatment chamber and means for generating the plasma. The plasma is generated in the hollow body. The energy necessary to generate the plasma is taken from an electric field between a U-shaped electrode outside of the hollow body and a tubular electrode which protrudes into the hollow body and also functions as a supply of a process gas into the hollow body.

In the international patent application WO 2005/099320 A2 a method and an apparatus for generating a low-pressure plasma are disclosed, in which a plasma is sucked through a non-adjustable plasma nozzle into a low pressure chamber by a reduced pressure. The invention also relates to various applications of the low-pressure plasma for surface treatment, for surface coating or for the treatment of gases.

The European Patent EP 0 887 437 B1 discloses a method for depositing an adherent coating onto the surface of a substrate by plasma deposition. It comprises the formation of an oxygen-containing plasma by a direct current arc plasma generator, injecting a reactant gas into the plasma outside the plasma generator, directing the plasma into a vacuum chamber by a diverging nozzle injector, which connects the plasma generator and the vacuum chamber. In this way the reactive species formed from the oxygen and reactant gas contacts the surface of the substrate for a sufficient time to form an adherent coating. The plasma generator is referred to as a cascade shaped arc plasma torch. The layer systems mentioned comprise, inter alia, silicon oxide deposition from hexamethyldisiloxane (HMDSO).

In U.S. Pat. No. 5,853,815 A a device for plasma-assisted coating of flat substrates is disclosed. A static plasma expands from a plasma gun, which is located inside a pressure chamber. To the plasma in the plasma gun a powder may be supplied, which is modified by the plasma and mixed with it in order to achieve a uniform distribution or coating on the workpiece to be treated.

The international patent application WO 95/22413 A1 discloses at least one method and at least one apparatus for creating inert or impermeable interior surfaces of vessels, particularly of plastic, as well as their coating with polymers. The vessels to be treated are placed in a vacuum chamber. Into each vessel a respective supply line for a process gas can be introduced. A plasma is ignited with process gas within the vessels by applying a voltage between electrodes that are located outside the vessels, or by microwave radiation. The voltage may be a DC voltage or a high frequency AC voltage. Prior to plasma ignition one or plural coating materials or process gases can be fed to the process gas. A sequence controller controls the process sequence of the coating process by controlling vacuum valves for creating a vacuum in the vacuum chamber, controlling the process gas supply to the vessels, and controlling a plasma generator connected to the electrodes. It is neither described that the plasma is generated only outside the vessel, nor by which means or measures it is supplied to the vessel, in particular in a controlled manner.

### SUMMARY OF THE INVENTION

It is an object of the invention to provide an apparatus for the efficient, gentle and complete cleaning and/or treatment of the interior surface of one or plural hollow bodies.

This object is achieved by an apparatus for the plasma treatment of hollow bodies comprising:
a process chamber for receiving at least one hollow body to be treated;
at least one plasma source with a power source for generating a plasma wherein the at least one plasma source is located outside of the process chamber;
at least one suction device for setting a pressure difference between the plasma source and the process chamber;
a control unit is provided for controlling the power source in such a way that a pulsating plasma can be generated;
a plasma guide with an outlet for a supply of a reacting plasma to each hollow body protrudes through an opening of the respective hollow body; and
a first supply control unit for controlling the supply of the reacting plasma into the respective hollow body is carried by the plasma guide.

It is also an object of the invention to develop a method by which the interior surface of one or plural hollow bodies can be effectively, gently, and completely cleaned and/or treated.

This object is achieved by a method for the plasma treatment of hollow bodies comprising the following steps:
placing at least one hollow body into a process chamber and setting a pressure in the process chamber by means of a suction device such that between at least one plasma source and the process chamber a pressure difference is formed;
generating a pulsed plasma in the at least one plasma source;
inserting a respective plasma guide into each hollow body, so that plasma from the plasma source is supplied via a first supply control unit into each hollow body placed within the pressure chamber; and
opening of the first supply control unit in a controlled manner, so that a pulsed and reacting plasma spreads uniformly within each hollow body.

The inventive apparatus for the plasma treatment of hollow bodies comprises a process chamber for receiving at least one hollow body to be treated. The apparatus further comprises at least one plasma source for generating a plasma. A power source feeds the plasma source with the energy necessary to turn a process gas in it into a plasma. The power source may, for example, be a voltage source, a radiation source (for example, a microwave source), or a heat source. At least one suction device sets a pressure difference between the plasma source and the process chamber. According to the invention the at least one plasma source is arranged outside the process chamber and is in fluid communication with it. The power source is controllable by a control unit in such a way that a pulsating plasma can be generated. A respective plasma guide, each with an outlet for a supply of reacting plasma, protrudes through an opening of each hollow body.

According to a further embodiment of the apparatus according to the invention, each plasma guide carries a respective first supply control unit for controlling the supply of plasma into the respective hollow body. Both the opening of the chamber through which the plasma source is in fluid communication with it, and the outlet of the plasma guide can be designed as a nozzle or sprayer in order to mix the plasma and substances possibly contained therein, to distribute them homogeneously and/or to modulate a directed plasma beam.

The plasma guide is preferably configured and positioned in such a way that if it is inserted into the hollow body, along the opening of the hollow body a circumferential gap area is formed. This gap area thus provides a fluid connection of the hollow body with the process chamber. At the same time it is a flow impedance for gas and/or plasma exiting from the hollow body. By suitable shaping of the gap area and corresponding adjustment of the effective pump power of the suction device and of the supply of plasma by means of the first supply control unit, an excess pressure can be set in the hollow body in relation to the process chamber. In particular, the flow of plasma from the hollow body can be homogenized by means of a circumferentially uniform configuration of the gap area, so that the reacting plasma uniformly affects the interior surface of the hollow body.

To adjust the flow conditions in such a way, for example the outlet of the plasma guide needs to be suitably positioned. It is advisable to arrange the plasma guide concentrically with the opening of the hollow body and to insert the outlet of the plasma guide suitably deeply into the hollow body.

The inventive apparatus, for the purpose of coating or chemical treatment, can be extended with a supply line for supplying a process material, the supply line opening into the plasma guide. The opening of the supply line to the plasma guide can be designed as a nozzle or sprayer, in order to distribute the process material uniformly in the plasma.

A second supply control unit may be provided upstream from the supply line for the supply of the process material.

The first and second supply control unit may be controllable in such a way that the supply of process material is adjustable in time and quantity to the supply of plasma. The control unit required therefor may for example be a computer or microcontroller which, via an interface, controls the supply control units in a manner adjusted to each other in time and quantity. Some processes require that the process material is in a suitable state of matter, has a suitable grain size or chemical state. The adjustable control has the advantage that the process material, prior to contact with the interior surface of the hollow body, can chemically react with the plasma or be dispersed completely.

According to further embodiment of the invention the apparatus for the plasma treatment encompasses the first supply control unit and the second supply control unit. The first supply control unit controls the supply of the reacting plasma into the respective hollow body. The second supply control unit is provided upstream from a supply line for the supply of process material. The supply line for the process material opens into the plasma guide.

Furthermore, the invention discloses a method for the plasma treatment of hollow bodies. In particular, the apparatus described above is suitable for this method. The method is characterized by the following steps:

At first at least one hollow body is introduced into and positioned in a process chamber. Subsequently, a suction device establishes a negative pressure in the process chamber with respect to at least one plasma source. The parameter range in which the negative pressure can be set depends on the effective pump power and the flow impedances. The flow impedances include the opening of the process chamber, the first and second supply control unit, the plasma guide and its outlet, the hollow body and the gap area between the opening of the hollow body and the plasma guide. Next, a pulsed plasma is generated in the plasma source. The plasma can be ignited and generated advantageously at atmospheric or higher pressure.

This plasma is supplied by a respective plasma guide into each hollow body. By the negative pressure in the process chamber and thus also in the hollow body with respect to the plasma source, the plasma of higher pressure (in the plasma source) becomes a plasma of lower pressure (in the process chamber and the hollow body), also called low pressure plasma.

The supply of plasma additionally can be controlled by a supply control unit, in such a manner that a pulsed reactive plasma spreads uniformly in each hollow body. Thereby in particular the thermal power of the plasma acting on the hollow body can be controlled or adjusted.

A plasma source, according to the invention, can be supplied with energy from a voltage source. The pulsing of the plasma can be further modulated by the voltage source outputting voltage pulses.

In particular, the voltage pulses may be DC pulses with a fixed or variable value of the pulse duration, pulse interval, and/or level of the voltage. By modulation of the voltage pulses the thermal power, the thermal and/or electro-static strains by the plasma on the hollow body can be adjusted.

In an extension of the method of the invention a coating or chemical reaction with one or plural components or reaction products of process gas and/or a process material, a polymerization or a preparatory or follow-up cleaning of the interior surface of the hollow body is performed with the plasma. The invention is in particular intended for hollow bodies such as plastic bottles, which are intended to contain food, beverages or medication. The follow-up cleaning step therefore needs to clean the interior surface of the bottles of residues of the coating or polymerization, as well as of other contaminants in accordance with the relevant hygiene standards.

The process material can be introduced via a supply line opening into the plasma guide. The first supply control unit and a second supply control unit for controlling the supply of process material can be controlled in such a way that the supply of process material is adjusted in time and quantity to the supply of plasma.

In order to reduce the thermal strain, between the pulses of plasma supplied to the hollow bodies, in addition a process gas can be supplied at least intermittently. Thereby, the heat generated by the plasma treatment is removed. The supply of the process gas for such a cooling of the hollow bodies can be controlled by the first and/or second supply control unit. A reduction in the supply of such a cooling gas reduces the cooling capacity, but allows the process to be conducted at lower average pressure.

The process material according to the invention may be a carrier gas, which carries an active substance in the form of vapor or spray or suspension. The plasma may be adjusted so that the active substances are specifically dispersed and vaporized or sublimed. Similarly, components of the active substance, of the process gas or of the hollow body may chemically react with each other. What chemical reactions can take place in what manner can be set by the characteristics of the plasma (e.g., plasma power, plasma pulsing, degree of ionization, gas temperature, ion temperature and electron temperature). The characteristics of the plasma can be modulated by corresponding control of the first supply control unit and/or the control unit and the effective pump power of the suction device. An example of active substances are hexamethyldisiloxane (HMDSO, for silicon oxide deposition) or hydrogen peroxide (H₂O₂). The carrier gas may, for example, consist of an oxygen-containing, hydrogen-containing or chemically inert gas mixture.

### BRIEF DESCRIPTION OF THE DRAWINGS

An embodiment of the invention will be described with reference to the accompanying figures. There is shown in

FIG. 1 a first sectional view through an apparatus according to the invention and a hollow body to be treated; and in

FIG. 2 a second sectional view through an apparatus according to the invention and a hollow body to be treated.

In the drawings, identical reference numerals are used for identical or equivalent elements of the invention.

### DETAILED DESCRIPTION OF THE INVENTION

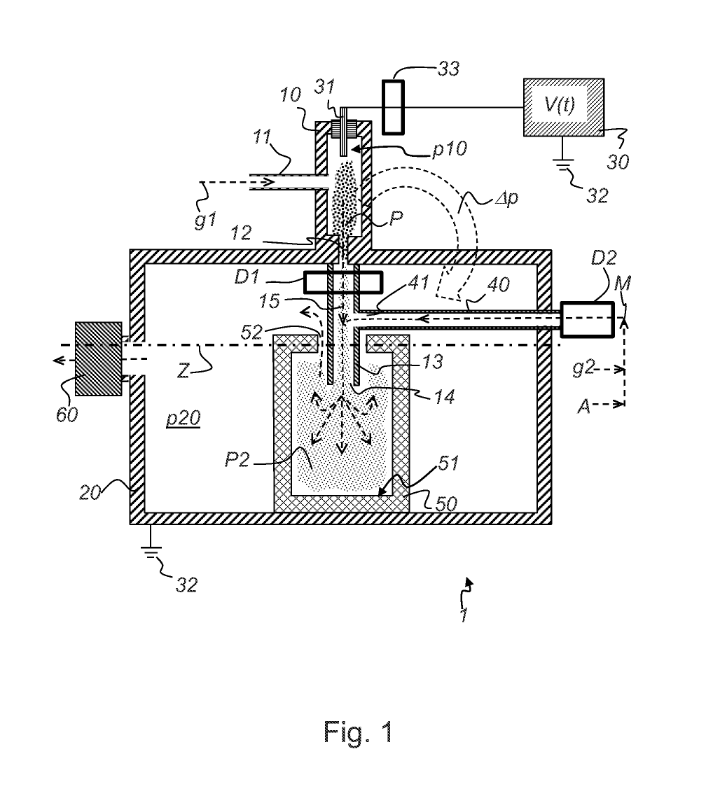

FIG. 1 shows an embodiment of the apparatus 1 according to the invention. In a process chamber 20 at least one hollow body 50 to be treated is located. A plasma source 10 is disposed outside the process chamber 20. Through an outlet 12 it is in fluid communication with the process chamber 20. The outlet 12 can also be designed as a nozzle. Via a feed 11 a process gas g1 can be supplied to the plasma source 10. A power source 30 can ignite a plasma P from the process gas g1 by applying a voltage to an active electrode 31 with respect to the common ground 32 of voltage source 30, plasma source 10 and process chamber 20. The common ground 32 prevents electrostatic charging effects or parasitic currents and plasma ignitions. The power source 30 may, by means of a control unit 33, output voltage pulses V(t), so that a pulsed plasma P is generated in the plasma source 10.

The process chamber 20 is in fluid connection with a suction device 60, so that a pressure difference Δp (a negative pressure) between the pressure p20 in the pressure chamber 20 against the pressure p10 in the plasma source 10 is generated. The plasma P from the plasma source 10 may pass through a plasma guide 13, which preferentially has an outlet 14 configured as a nozzle, into the hollow body 50 and expand. By expansion, the supplied plasma P2 has characteristics modulated with respect to the plasma P in the plasma source 10, in particular a lower pressure. The supply of plasma P can be controlled accurately in time or can be completely interrupted by a supply control unit Dl of the plasma guide 13. Plasma P2, process gas g1, process materials M or their reaction products can flow out into the process chamber 20 via an opening 52 of the hollow body 50. Due to the uniform expansion of plasma P2 into the hollow body 50 and the uniform flow out of it, the plasma P2 affects its interior surface 51 uniformly.

Into the plasma guide 13 there opens, downstream from the first supply control unit Dl, a supply line 40 for a process material M for coating, cleaning, sterilization, activation or polymerization of the interior surface 51 of the hollow body 50. The process material may comprise a carrier gas g2 and an active substance A or a mixture of active substances. The opening 41 of the supply line 40 may be implemented as a nozzle or as a sprayer for the process material M. A second supply control unit D2 controls the supply of process material M in time and quantity. In particular, the invention provides to adjust to each other in time the first and second supply control unit D1 and D2 and/or the control unit 33 of the voltage source 30. In this way the plasma P2 can be modulated (in particular pulsed) and the supply of process material M can be adjusted in time and quantity to the supply of plasma P2.

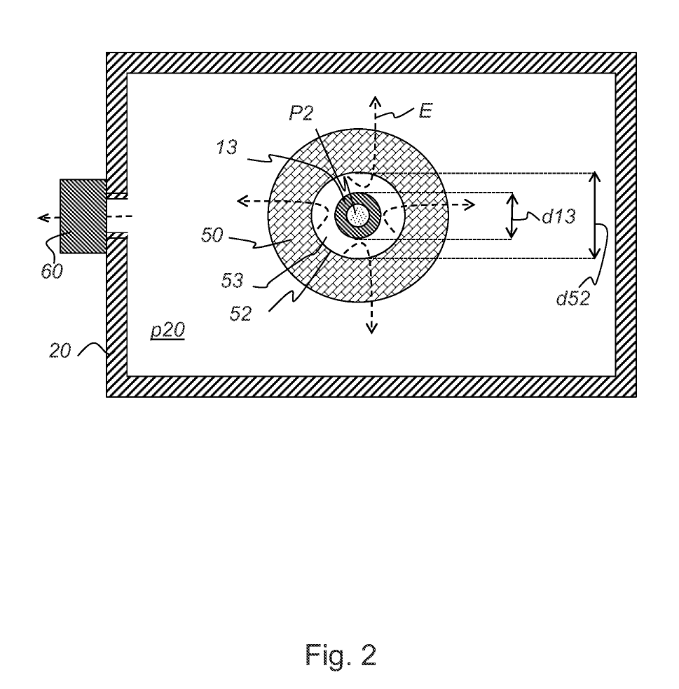

FIG. 2 shows a section through the apparatus described above in FIG. 1, taken along the dot-dashed line Z. The plasma guide 13 protrudes through an opening 52 of the hollow body 50 so that the outlet 14 for the reacting plasma P2 is within the hollow body 50. Its immersion depth is a parameter to be set for the uniform distribution of reacting plasma P2 on the interior surface 51 of the hollow body 50. For example, a hollow body 50 to be processed has a round opening 52; adapted to this round shape the plasma guide 13 in the embodiment shown has a round cross section. The plasma guide 13 has an outside diameter d13 smaller than an inner diameter d52 of the opening 52 of the hollow body 50. The plasma guide 13 is positioned concentrically with the opening 52 of the hollow body 50. Due to the circumferential gap 53 formed in this way a uniform flow E from the hollow body 50 is ensured. Thus, a uniform action of the plasma P, and/or of the process material M on the entire interior surface 51 of the hollow body 50 is achieved. A further advantage of this embodiment according to the invention is that selectively only the interior surface 51 of the hollow body 50 is treated.

### LIST OF REFERENCE NUMBERS

1 apparatus

10 plasma source

11 supply of the process gas

12 outlet of the plasma source

13 plasma guide

14 outlet

20 process chamber

30 voltage source

31 electrode

32 common ground

33 control unit

40 supply line of the process material

41 opening

50 hollow body

51 interior surface of the hollow body

52 opening of the hollow body

53 circumferential gap area

60 suction device

g1 process gas

g2 carrier gas

M process material

A active substance

V(t) voltage

D1 first supply control unit

D2 second supply control unit

p10 pressure in the plasma source

p20 low pressure in the low-pressure chamber

Δp pressure difference

P plasma

P2 reacting plasma supplied to the hollow body

Z-Z section line for FIG. 2

d13 outer diameter

d52 inner diameter

E flow from the hollow body

What is claimed is:

1. An apparatus for the plasma treatment of hollow bodies, comprising:
a process chamber for receiving at least one hollow body to be treated;
at least one plasma source with a power source for generating a plasma wherein the at least one plasma source is located outside of the process chamber;
at least one suction device for setting a pressure difference between the plasma source and the process chamber;
a control unit is provided for controlling the power source in such a way that a pulsating plasma can be generated;
a plasma guide with an outlet for a supply of a reacting plasma to each hollow body protrudes through an opening of the respective hollow body; and
a first supply control unit for controlling the supply of the reacting plasma into the respective hollow body is carried by the plasma guide.

2. Apparatus (1) according to claim 1, wherein between the plasma guide (13) and the opening (52) of the hollow body (50) a circumferential gap area (53) is formed, by which a fluid connection from inside the hollow body (50) to the process chamber (20) is formed.

3. Apparatus (1) according to claim 1, wherein the outlet (14) of the plasma guide (13) is positioned within the hollow body (50) and/or wherein the supply control unit (D1) and the suction device (60) are adjustable to each other, so that the reacting plasma (P2) supplied to the hollow body (50) is uniformly spreadable over an interior surface (51) of the hollow body (50).

4. Apparatus (1) according to claim 1, wherein a supply line (40) for supplying a process material (M) opens into the plasma guide (13).

5. Apparatus according to claim 4, wherein a second supply control unit (D2) is provided upstream from the supply line (40) for the supply of process material (M).

6. Apparatus (1) according to claim 5, wherein the first and the second supply control unit (D1, D2) are controllable in such a way that the supply of process material (M) is adjustable in time and quantity to the supply of the reacting plasma (P2).

7. Method for the plasma treatment of hollow bodies, comprising the following steps:
placing at least one hollow body into a process chamber and setting a pressure in the process chamber by means of a suction device such that between at least one plasma source and the process chamber a pressure difference is formed;
generating a pulsed plasma in the at least one plasma source;
inserting a respective plasma guide into each hollow body, so that plasma from the plasma source is supplied via a first supply control unit into each hollow body placed within the pressure chamber; and
opening of the first supply control unit in a controlled manner, so that a pulsed and reacting plasma spreads uniformly within each hollow body.

8. Method according to claim 7, wherein each plasma source is connected with a power source, which outputs voltage pulses for generating the pulsed plasma.

9. Method according to claim 8, wherein the voltage pulses are DC voltage pulses with fixed or variable values of pulse duration, pulse interval and/or level of the voltage.

10. Method according to claim 9, wherein by modulation of the voltage pulses (V(t)) the thermal and/or electrostatic strain from the plasma (P) and/or from the reacting plasma (P2) supplied into the hollow body (50) is set.

11. Method according to claim 7, wherein with the plasma (P) from the plasma source (10) a coating or chemical reaction with one or plural components or reaction products of process gas (g1) for the generation of plasma and/or a process material (M), a polymerization or a preparatory or follow-up cleaning of the interior surface (51) of the hollow body (50) is performed.

12. Method according to claim 11, wherein the process material (M) is supplied via a supply line (40) opening into the plasma guide (13).

13. Method according to claim 12, wherein the first supply control unit (Dl) and a second supply control unit (D2) for controlling the supply of process material (M) are controlled in such a way that the supply of process material (M) is adjusted in time and quantity to the supply of plasma (P).

14. Method according to claim 7, wherein between the pulses of the reactive plasma (P2) supplied to the at least one hollow body (50) also a process gas (g1) for removing the heat generated by the plasma treatment is supplied at least intermittently.

15. Method of one of the claims 11, wherein the process material (M) is a carrier gas (g2) carrying an active substance (A) as vapor or spray or suspension.

16. An apparatus for the plasma treatment of hollow bodies (50), comprising:
a process chamber (20) for receiving at least one hollow body (50) to be treated;
at least one plasma source (10) with a power source (30) for generating a plasma (P) wherein the at least one plasma source (10) is located outside of the process chamber (20);
at least one suction device (60) for setting a pressure difference (Op) between the plasma source (10) and the process chamber (20);
a control unit (33) is provided for controlling the power source (30) in such a way that a pulsating plasma (P) can be generated;
a plasma guide (13) with an outlet (14) for a supply (15) of a reacting plasma (P2) to each hollow body (50) protrudes through an opening (52) of the respective hollow body (50);
a first supply control unit (D1) for controlling the supply (15) of the reacting plasma (P2) into the respective hollow body (50) is carried by the plasma guide (13); and
a second supply control unit (D2) is provided upstream from a supply line (40) for the supply of process material (M) wherein the supply line opens into the plasma guide (13).
